(19) United States
(12) Patent Application Publication
(10) Pub. No.: US 2015/0337089 A1
(43) Pub. Date: Nov. 26, 2015

(54) ANIONIC ISOCYANATE COMPOUND AND ITS USE AS EMULSIFIER

(71) Applicants: ROHM AND HAAS COMPANY, Philadelphia, PA (US); DOW GLOBAL TECHNOLOGIES LLC, Midland, MI (US)

(72) Inventors: Yongchun CHEN, Shanghai (CN); Guoling HOU, Shanghai (CN); Shiling ZHANG, Shanghai (CN)

(21) Appl. No.: 14/437,513

(22) PCT Filed: Oct. 28, 2013
(86) PCT No.: PCT/CN2013/086025

§ 371 Date: Apr. 22, 2015

(30) Foreign Application Priority Data
Oct. 29, 2012 (CN) 201210421396.8

(51) Int. Cl. C08J 3/24

(52) U.S. Cl. CPC C08J 3/24

(57) ABSTRACT

Provided is a composition comprising
(a) one or more polyisocyanate, wherein said polyisocyanate has the structure of formula I:

A-NCO I
and
(b) one or more compound having the structure of formula II:

A-L-Q-G II
wherein
   A in structure II is identical to A in structure I,
   L is a linking group formed by a reaction of an isocyanate group with an isocyanate-reactive group,
   Q is an organic group, and
   G is an anionic group, and
wherein the ratio of the sum of the moles of isocyanate groups plus the moles of said L groups to the moles of said Q groups is 3:1 to 10:1.

Also provided is an emulsion in which the particles comprise such a composition and further comprise (c) one or more water-insoluble compound that is different from said polyisocyanate (a).

It is often desirable to provide a water-insoluble compound in a waterborne composition. One possible approach to this goal is to attempt to form an emulsion of droplets in water, where the droplets contain the water-insoluble compound and where those droplets are stabilized by an emulsifier. In such an emulsion, it is sometimes also desirable that the emulsifier is reactive and capable of acting as a crosslinker

U.S. Pat. No. 6,767,958 describes a reaction product of a polyisocyanate with 2-(cyclohexylamino)-ethanesulfonic acid and/or 3-(cyclohexylamino)-propanesulfonic acid.

It is desired to provide a compound that has one or more isocyanate groups and that is capable of acting as an emulsifier for stabilizing emulsions of water-insoluble compounds. Also desired are emulsions made of such water-insoluble compounds and such emulsifiers. It is further desired to provide a compound that has one or more isocyanate groups and that is reactive and capable of acting as an emulsifier for stabilizing emulsions of water-insoluble aromatic polyisocyanates. Also desired are emulsions made of such aromatic polyisocyanates and such emulsifiers.

The first aspect of the present invention is a composition comprising
(a) one or more polyisocyanate, wherein said polyisocyanate has the structure of formula I:

A-NCO I

and
(b) one or more compound having the structure of formula II:

A-L-Q-G II

wherein
A in structure II is identical to A in structure I,
L is a linking group formed by a reaction of an isocyanate group with an isocyanate-reactive group,
Q is an organic group, and
G is an anionic group, and

wherein the ratio of the sum of the moles of isocyanate groups plus the moles of said L groups to the moles of said Q groups is 3:1 to 10:1.

The second aspect of the present invention is an emulsion comprising particles suspended in an aqueous medium, wherein said particles comprise the composition of the first aspect of the present invention and further comprising (c) one or more water-insoluble compound that is different from said polyisocyanate (a)

The following is a detailed description of the invention.

As used herein, the following terms have the designated definitions, unless the context clearly indicates otherwise.

The isocyanate group is —NCO. A polyisocyanate is a compound having two or more isocyanate groups. Some polyisocyanates are polymers and some are not. A diisocyanate is a compound that has exactly two isocyanate groups. The structure of a diiosocyanate is OCN—R—NCO, where R is any organic group, which may be substituted or unsubstituted. If R is aliphatic, the diisocyanate is an aliphatic diisocyanate. If R contains any aromatic ring, the diisocyanate is an aromatic diisocyanate.

A dimer of a diisocyanate has the structure VI:

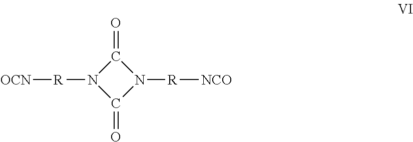

Because structure VI is the dimer of a diisocyanate, the R groups in structure VI are identical to each other. A diisocyanate that is not a dimer of any diisocyanate is known herein as a monomer of a diisocyanate.

A trimer of a diisocyanate has the structure III:

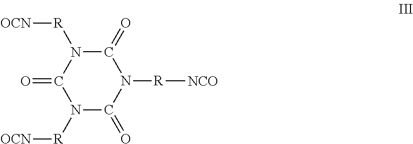

Because structure III is the trimer of a diisocyanate, the R groups in structure III are identical to each other.

As used herein, a “residue” of a polyisocyanate is what remains of the structure of that polyisocyanate when a single isocyanate group is disregarded. A polyisocyanate has the structure A-NCO, where A is the residue of the polyisocyanate. The residue of a polyisocyanate has at least one isocyanate group. For Example, structure III may be re-drawn to have the structure AT-NCO, where AT is the residue of the trimer of a diisocyanate. AT has two isocyanate groups.

As used herein, an isocyanate-reactive group is a group that is capable of reacting with an isocyanate group. A linking group is the group formed when an isocyanate group reacts with an isocyanate-reactive group. For example, when an isocyanate group reacts with a hydroxyl group or with an amine group, the resulting linking group is a urethane group or a urea group, respectively. The urea group has structure IV:

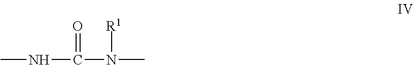

where R¹ is an organic group.

As used herein, an anionic group is a chemical group that carries negative charge. The negative charge may be −1, −2, or −3. A compound with an anionic group is associated with one or more cation. The associated cation may be a metal cation or an organic compound with a cationic group (i.e., a group have a positive charge of +1, +2, or +3). When a compound with an anionic group is in solid form or is in a nonpolar environment, the associated cation(s) is located adjacent to the anionic group. When such a compound is dissolved in water, the anionic group and the associated cation(s) may be separated.

As used herein, an epoxy compound is a compound having one or more epoxy group. A polyepoxy compound is a compound having two or more epoxy groups. A polyepoxy compound may or may not be a polymer.

As used herein a crosslinker is a compound that has two or more reactive groups and that is capable of reacting with reactive groups attached to polymer chains to form crosslinks between polymer chains. The reactive groups on the crosslinker may be the same as or different from the reactive groups attached to the polymer chains.

An aqueous medium is a continuous medium that contains 50% or more water by weight based on the weight of the continuous medium. As used herein, an emulsion is a dispersion of particles distributed through an aqueous medium. The particles in an emulsion may have weight-average particle diameter of 10 nm to 10 micrometer. Weight-average particle diameter herein is known as D50.

A compound is considered herein to be water-insoluble if the maximum amount of that compound that can dissolve in 100 g of water at 25° C. is 0.5 grams.

As used herein, the statement that a ratio is X:1 or higher means that the ratio is V:1, where V is equal to or greater than X. Similarly, the statement that a ratio is Z:1 or lower means that the ratio is W:1, where W is equal to or less than Z.

The composition of the present invention contains a polyisocyanate, herein referred to as “polyisocyanate (a).” Polyisocyanate (a) has the structure I:

A-NCO I

where A is the residue of polyisocyanate (a). Preferably, polyisocyanate (a) is a monomer of a diisocyanate, a dimer of a diisocyanate, or a trimer of a diisocyanate. More preferably, polyisocyanate (a) is a dimer of a diisocyanate or a trimer of a diisocyanate. More preferably, polyisocyanate (a) is a trimer of a diisocyanate.

Certain diisocyanates are preferred for use in polyisocyanate (a). The same diisocyanates are preferred whether used as a monomer of a diisocyanate or as the building blocks for a dimer of a polyisocyanate or a trimer of a polyisocyanate. Preferred diisocyanates for use in polyisocyanate (a) are aliphatic diisocyanates. More preferred are 1,6 hexamethylene diisocyanate (HDI), 1-isocyanato-3-isocyanatomethyl-3,5,5-trimethyl-cyclohexane (IPDI), 4,4′-diisocyanato dicyclohexylmethane (H₁₂MDI), and di-isocyanatomethyl-cyclohexane (ADI). More preferred are HDI and ADI.

In preferred embodiments, polyisocyanate (a) is a trimer of a diisocyanate (herein called “trimer (a)”) having structure III. Trimer (a) has the structure I:

AT-NCO I

In trimer (a), residue AT- has the structure V:

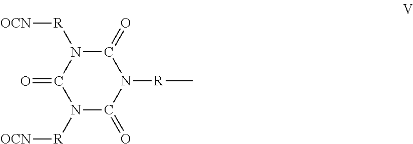

The diisocyanate of which trimer (a) is the trimer is known herein as “diisocyanate (a).”

The composition of the present invention contains a compound (herein called “compound (b)”) having structure II:

A-L-Q-G II

where A in structure II is identical to A in structure I; L is a linking group formed by a reaction of an isocyanate group with an isocyanate-reactive group, Q is an organic group, and R is an anionic group.

Preferably, L is a urea group or a urethane group. More preferably, L is a urea group having structure IV. More preferably L is a urea group having structure IV in which R¹ is an unsubstituted alkyl group; more preferably R¹ is an alkyl group having 4 to 8 carbon atoms; more preferably R¹ is cyclohexyl.

Preferably, Q is an alkyl group that is linear, branched, cyclic, or a combination thereof. More preferably, Q is a linear alkyl group. More preferably, Q is —(CH₂)ₙ- where n is 1 to 8. More preferably, Q is —(CH₂)ₙ- where n is 3.

Preferably, G is sulfonate or carboxylate. More preferably G is sulfonate.

The composition of the present invention comprises a mixture of polyisocyanate (a) and compound (b). This mixture may be characterized by a ratio M-ISO:M-Q. As used herein M-ISO is the sum of the moles of NCO groups plus the moles of L groups. M-Q is the moles of Q groups.

The ratio M-ISO:M-Q may be illustrated by an example. In some embodiments, the composition of the present invention is made by a process that includes a chemical reaction between a polyisocyanate (a), a compound having structure VI:

R²—NH-Q-GH VI

where R² is an organic group, and a compound having structure VII:

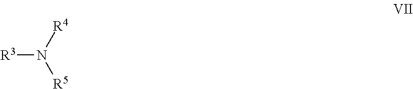

where R³, R⁴, and R⁵ is each an organic group.

In such embodiments, an NCO group on polyisocyanate (a) reacts with the NH group on the compound VI; also, the H attached to the G of compound VI transfers to compound VII, and compound VII becomes a quaternary cation. When contemplating such a chemical reaction, it is useful to characterize reactants prior to the chemical reaction by examining the ratio (herein called the NCO:NH ratio) of the moles of NCO groups on the polyisocyanate (a) to the moles of NH groups on compound VI. In this example, the number of moles of Q groups is the same as the number of moles of NH groups. In this example, during the chemical reaction, some or all of the NCO groups will react with some or all of the NH groups, and so some or all of the NCO groups will be converted into urea groups (the L groups in this example). The quantity M-ISO will be the same as the number of moles of NCO groups present in the reactants prior to the chemical reaction. The ratio M-ISO:M-Q of the products after the chemical reaction is the same as the ratio NCO:NH of the reactants prior to the reaction.

M-ISO:M-Q is 3:1 or higher; preferably 5:1 or higher; more preferably 6:1 or higher; preferably 7:1 or higher. M-ISO:M-Q is 10:1 or lower.

Some aspects of the present invention involve an emulsion that contains particles suspended in an aqueous medium. The particles contain polyisocyanate (a), compound (b), and an additional compound (herein called “compound (c)”). Compound (c) is water-insoluble and is different from both polyisocyanate (a) and compound (b).

While the present invention is not limited to any specific mechanism, it is contemplated that compound (c) and polyisocyanate (a) form a mixture in the interior of each particle and that compound (b) resides at the interface between the particle and the aqueous medium. It is contemplated that compound (c) acts as emulsifier to form and stabilize the particles.

Preferably, compound (c) is a crosslinker. More preferably, compound (c) is a polyepoxy compound or a polyisocyanate. More preferably, compound (c) is a polyisocyanate. For compound (c), preferred aliphatic polyisocyanates are HDI, IPDI, H₁₂MDI, ADI, isomers thereof, polymers thereof, and mixtures thereof. Compound (c) preferably is an aromatic polyisocyanate. For compound (c), preferred aromatic polyisocyanates are toluylene-2,4-diisocyanate (2,4-TDI), toluylene-2,6-diisocyanate (2,6-TDI), naphthylene-1,5-diisocyanate, diphenylmethane-4,4′-diisocyanate (MDI), isomers thereof, polymers thereof, and mixtures thereof. More preferred are 4,4′-MDI; 2,4′-MDI, and mixtures thereof.

Preferably the D50 of the particles is 10 nm or larger; more preferably 50 nm or larger. Preferably, the particles have D50 of 2,000 nm or smaller; more preferably 1,000 nm or smaller; more preferably 500 nm or smaller.

Preferably, the emulsion is stable. A stable emulsion does not show any phase separation, settling, floatation, or aggregation upon storage at 25° C. Preferably, the emulsion is stable for 2 hours or more; more preferably 5 hours or more; more preferably 10 hours or more.

In the emulsion of the present invention, it is useful to characterize the sum of the weight of polyisocyanate (a) plus the weight of compound (b) plus the weight of compound (c). This sum may be expressed as a percentage based on the total weight of the emulsion. The total weight of the emulsion includes the weight of the aqueous medium. Preferably, that sum is 0.5% or more; more preferably 1% or more; more preferably 2% or more; more preferably 3% or more. Preferably, that sum is 10% or less; more preferably 8% or less; more preferably 6% or less.

In the emulsion of the present invention, it is useful to characterize the ratio X:Y, where X is the weight of polyisocyanate (a) plus the weight of compound (b), and Y is the weight of compound (c). Preferably, X:Y is 0.05:1 or higher, more preferably 0.1:1 or higher; more preferably 0.2:1 or higher. Preferably, X:Y is 5:1 or lower; more preferably 2:1 or lower; more preferably 0.9:1 or lower.

It is sometimes useful, prior to making the emulsion that contains compound (c), to make the mixture of polyisocyanate (a) and compound (b) as described in the first aspect of the present invention, without including any compound (c). When a composition containing 4 parts by weight of such a mixture and 96 parts by weight of water, at 25° C., particles suspended in an aqueous medium will form, and preferably the D50 of the particles is 10 nm or larger. Preferably, such particles will have D50 of 1,000 nm or smaller; more preferably500 nm or smaller; more preferably 300 nm or smaller.

The following are examples of the present invention.

In the following examples, emulsion particle size was measured by 90Plus particle size analyzer from Brookhaven Instruments.

### COMPARATIVE EXAMPLE 1

### Anionic HDI

The following compounds were mixed together:
HDI
3-(cyclohexylamino)-1-propanesulfonic acid (“CAPS”)
N,N-dimethylcyclohexylamine (“DMCHA”)

The mole ratio of CAPS to DMCHA was 1:1. The mole ratio of NCO:NH was varied as shown below. The mixture of these compounds was heated at 80° C. for 3 hours. The reaction products included

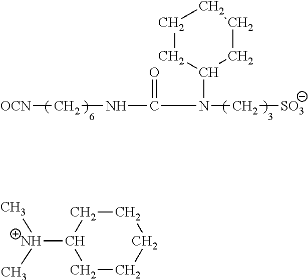

The reaction product was mixed with water at 4 parts by weight reaction product plus 96 parts by weight water. The results were as follows:

| NCO:NH mole ratio | Particle Size (nm) |
|---|---|
| 7:1 | 945 |
| 3:1 | agglomerate |
| 2:1 | agglomerate |

None of the samples in an emulsion with acceptably small particle size.

### COMPARATIVE EXAMPLE 2

### Anionic HDI Dimer

HDI dimer has the structure

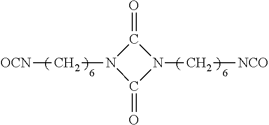

HDI dimer was mixed with CAPS and DMCHA and heated as described in Comparative Example 1. The NCO:NH mole ratio was varied and the mole ratio of DMCHA:CAPS was also varied, as shown below. The reaction product included the compound with the structure

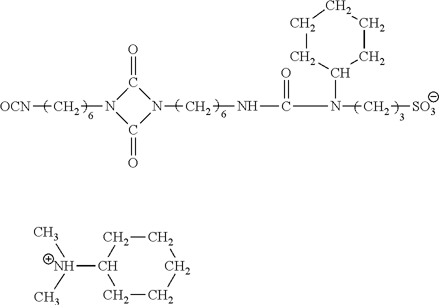

After each reaction, two mixtures were prepared:
Mixture 2-1: 4 parts by weight reaction product and 96 parts by weight water;
Mixture 2-2: 2 parts by weight reaction product, 2 parts by weight HDI trimer, and 96 parts by weight water.

The results were as follows:

| | | | Particle Size | |
|---|---|---|---|---|
| | NCO:NH | DMCHA:CAPS | (nm) | Particle Size (nm) |
| No. | mole ratio | mole ratio | Mixture 2-1 | Mixture 2-2 |
| 2a | 10:1 | 1:1 | 60 | 6,000 |
| 2b | 6:1 | 1:1 | 27 | 896 |
| 2c | 6:1 | 1.5:1 | 95 | 1,200 |
| 2d | 6:1 | 2:1 | 207 | 310 |
| 2e | 3:1 | 1:1 | solution | not tested |

In the 2-2 Mixtures, samples 2a, 2b, and 2c had unacceptably large particle size. Sample 2d had unacceptably large amount of free DMCHA; sample 2d had an unpleasant smell; and it is expected that the large amount of free DMCHA would cause degradation of other properties. Sample 2e dissolved in water and thus did not form an emulsion when it was mixed with water. It is expected that sample 2e could therefore not act as an emulsifier for any compound (c). Therefore none of samples 2a-2e is useful for forming an emulsion when HDI trimer is used as compound (c).

### EXAMPLE 3

### Anionic HDI Trimer Without Compound (c)

HDI trimer has structure III where —R— is —(CH₂)₆—. HDI trimer was mixed with CAPS and DMCHA and reacted as described in Comparative Example 1. Mole ratio of CAPS:DMCHA was 1:1. The reaction product contained a compound having the following structure:

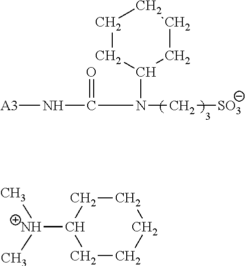

where A3 is the residue of HDI trimer.

The reaction product was mixed with water at 4 parts by weight reaction product and 96 parts by weight water, and if an emulsion was formed, the particle size was measured. The results were as follows:

| NCO:NH mole ratio | Particle Size (nm) |
|---|---|
| 14:1 | 41.5 |
| 10:1 | 26 |
| 7:1 | 20 |
| 4:1 | precipitate |

The sample with NCO:NH ratio of 4:1 was not acceptable. The samples with NCO:NH ratio of 7:1 and 10:1 had desirably low particle size, lower than the sample at 14:1.

### EXAMPLE 4

### Anionic HDI Trimer with Compound (c)

Ingredients were mixed and reacted as in Example 3. The NCO:NH mole ratio was 7:1. The DMCHA:CAPS mole ratio was 1:1. Mixtures were made with various additional compounds, as follows:

| Abbreviation | Compound | Supplier |
|---|---|---|
| Epoxy | D.E.R. ™ 331 ™ liquid epoxy | The Dow Chemical Co. |
| | resin | |
| MDI-L | Isonate ™ 50 OP isocyanate; | The Dow Chemical Co. |
| | liquid; 50% 4,4′ MDI and 50% | |
| | 2,4′ MDI | |
| MDI-S | Isonate ™ 125M isocyanate; | The Dow Chemical Co. |
| | solid; 98% 4,4′ MDI and 2% | |
| | 2,4′ MDI | |
| IPDI | isophorone diisocyanate | Alfa Aesar |
| ADI trimer | structure III where R is | |
| | bis(methylene)cyclohexyl | |

Each mixture contained 96 parts by weight of water, X parts by weight of reaction product (of the reaction between HDI trimer, CAPS, and DMCHA), and Y parts by weight of additional compound, where X+Y equaled 4 parts by weight. The ratio X:Y is shown below. The particle sizes of the mixtures were measured with the results as follows:

| additional compound | X:Y | D50 (nm) |
|---|---|---|
| MDI-L | 0.5:1 | 82 |
| MDI-S | 0.5:1 | 85 |
| IPDI | 0.5:1 | 116 |
| ADI trimer | 0.5:1 | 36 |
| Epoxy | 0.25:1 | 83 |
| Epoxy | 0.5:1 | 950 |
| Epoxy | 1.0:1 | agglomerate |
| Epoxy | 1.5:1 | agglomerate |

The reaction product of HDI trimer with CAPS and DMCHA at NCO:NH mole ratio of 7:1 acts as an useful emulsifier for a variety of additional compounds. Also, it is possible to vary D50 by varying the ratio X:Y.

1. A composition comprising
(a) one or more polyisocyanate, wherein said polyisocyanate has the structure of formula I:
A-NCO I
and
(b) one or more compound having the structure of formula II:
A-L-Q-G II
wherein
A in structure II is identical to A in structure I,
L is a linking group formed by a reaction of an isocyanate group with an isocyanate-reactive group,
Q is an organic group, and
G is an anionic group, and
wherein the ratio of the sum of the moles of isocyanate groups plus the moles of said L groups to the moles of said Q groups is 3:1 to 10:1.

2. The composition of claim 1 wherein said polyisocyanate (a) is a trimer of a diisocyanate.

3. The composition of claim 2 wherein said ratio of the sum of the moles of isocyanate groups plus the moles of said L groups to the moles of said Q groups is 6:1 to 10:1

4. The composition of claim 3 wherein A is a residue of a trimer of hexane diisocyanate.

5. The composition of claim 3 wherein L is a urea group.

6. The composition of claim 3 wherein G is a sulfonate group.

7. An emulsion comprising particles suspended in an aqueous medium, wherein said particles comprise
(a) one or more polyisocyanate, wherein said polyisocyanate has the structure of formula I:
A-NCO I
(b) one or more compound having the structure of formula II:
A-L-Q-G II
and
(c) one or more water-insoluble compound that is different from said polyisocyanate (a),
wherein
A in structure II is identical to A in structure I,
L is a linking group formed by a reaction of an isocyanate group with an isocyanate-reactive group,
Q is an organic group, and
G is an anionic group, and
wherein the ratio of the sum of the moles of isocyanate groups plus the moles of said L groups to the moles of said Q groups is 3:1 to 10:1.

8. The emulsion of claim 7 wherein said water-insoluble compound (c) is a polyisocyanate.

9. The emulsion of claim 8 wherein said polyisocyanate is an aromatic polyisocyanate.
